(19) United States
(12) Patent Application Publication
(10) Pub. No.: US 2005/0007337 A1
(43) Pub. Date: Jan. 13, 2005

(54) Data communication system, method and personal article

(76) Inventors: Abigail Jane Sellen, Newbury (GB); Rachel Lucy Murphy, Bristol (GB); Jeroen Geert Bijsmans, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/489,795

(22) PCT Filed: Jan. 20, 2003
(86) PCT No.: PCT/GB03/00205

(30) Foreign Application Priority Data
Jan. 19, 2002 (GB) 0201225.0

(51) Int. Cl. G09G 5/00

(52) U.S. Cl. 345/156

(57) ABSTRACT

Devices exist that can access and retrieve data from the Internet. These devices use a web-browser of some form to achieve this end. To retrieve a-rid render web-pages using a web-protocol, such as, for example, HTTP or WAP, requires a relatively sophisticated client device. Such a client device requires large amounts of memory and a relatively powerful processor to run the web-browser to access data sources such as, for example, the Internet directly. However, often users are only interested in specific, small volume, data such as a current share or stock price, exchange rate or temperature, for example. Hence, using such a relatively sophisticated device as described above to achieve a relative simple aim is unsuitable. Therefore, embodiments provide a data communication system comprising data specification means for a user to specify at least one data item and preferably a number of items of data, data capture means for capturing specified at least an item of specified data from data sources and a data display device for downloading, wirelessly, at least one item of data from the data capture means, wherein the data display device is incorporated in a personal article.

### FIELD OF THE INVENTION

The present invention concerns a communication system and method and, more particularly, to such a system and method for specifying distributed information sources, obtaining data from those sources and communicating that data by wireless communication to a mobile display device.

### BACKGROUND TO THE INVENTION

There are known devices that enable a user, whilst mobile, to obtain data from data sources. For example, WO 00/50963 discloses a wearable device that wirelessly receives financial information for output to the wearer of the device. The main function of the device is as a watch and the display of financial information is an additional function. However, the device is dedicated to communication with one particular data source.

Devices are known which facilitate wireless access to the Internet and multiple data sources such as, for example, WAP mobile telephones. However, in common with personal computers these tend to use web browsing software which, before a user can access a web site, must be loaded and directed using appropriate URLs or by selecting a pre-stored address. An example of such a device is disclosed in WO 01/82027 A2.

In the case of frequently accessed sites, and many users access a selected number of sites frequently, this can be burdensome, particularly if it is only a single selected item of data, such as a share price, sports score, train time etc, from the site in which the user is interested. WO 01/71557 A2 discloses a system that attempts to reduce the traffic-carrying requirement of such a system by transmitting only the data of interest. However, the system requires a relatively sophisticated client application to be executing at the receiving device, which positions the received data correctly within a previously rendered HTML page. The processing and memory requirements to support such a client application are unsuitable for thin client applications.

It is an object of embodiments of the present invention at least to mitigate some of the problems of the prior art.

### SUMMARY OF INVENTION

Accordingly, a first aspect of embodiments of the present invention provides a data communication system comprising data specification means for a user to specify a number of items of data, data capture means for capturing the specified items of data from data sources and a data display device for downloading at least one of the captured items of data by wireless communication from the data capture means, wherein the data display device is incorporated in a watch.

Advantageously, embodiments of the present invention may enable a user to gain mobile access to multiple data sources without the need for excessive time, effort and complexity and without requiring a relatively thick client application to be executed at the client device.

A second aspect of embodiments of the present invention provides a data communication system comprising data specification means to allow specification of a number of data items, data capture means to capture the specified data items from data sources and a data display device to download the specified items of data by wireless communication from the data capture means, wherein the display device is incorporated in a personal article, which personal article has an additional function.

The phrase “a personal article” as used in this specification comprises or means any article a user may carry, wear or have about their person.

The additional function may be any function that an article personal to the user may perform, which is additional to the article's function as a data display device and which is a non-wireless communication related function. The additional function may be the main function of the personal article. For example, the additional function may be as a watch, key ring, a pen or other writing instrument, jewellery or other adornment, a pen knife or tool(s), torch, a bag, a purse or wallet, spectacles, a game or plaything, a camera, or an item of clothing or footwear.

Embodiments of the present invention enable a user, in possession of the personal article incorporating a data display device, to access a plurality of data sources and, specifically, data items selected from those data sources. Moreover, the data display device is not dedicated to those particular sources. Instead data sources can be specified by the user. In effect, specification of the data sources by the user with a separate device, data specification means or selector, and capturing the specified data at a further device, data capture means, that is, a data captor or capturer, enables a browsing or equivalent-type software function to be dispensed with at the data display device. Moreover, the “form” of the data display device, that is, its incorporation into a personal article means that access to data sources does not necessitate an additional article. Thus, the time, effort and complexity involved in gaining access to the specified data items is reduced as compared, for example, to using a PDA or WAP enabled device.

The data display device may comprise means for requesting the download of items of data. The data display device preferably comprises processing circuitry and the requesting means is linked to processing circuitry which, in response to operation of the requesting means, generates a request wirelessly communicated to the data capture means for downloading data from the data capture means. The requesting means may comprise means for selecting a specific item of data for downloading. The selecting means may support repeated downloading of an item of data. The selecting means may be operable to select an item of data for downloading repeatedly at specified time intervals or when the item changes. The selecting means may be operable to adopt any one of a number of states, the number corresponding to the number of data items specified. The selecting means may also further comprise indicia so as to enable a user to identify which state corresponds to which data item.

Embodiments of the data display device further comprise communications means enabling wireless communications between the data display device and the data capture means. The data display device also further comprises a display for displaying downloaded items of data. Preferably, the data display device comprises audible alert means for announcing the completion of downloading. Still further, the data display device preferably comprises a memory for retaining downloaded data items, for example, in readiness for display or for comparison with at least one other previously downloaded data item.

The requesting means may be a switch arrangement or other actuator arrangement capable of initiating a request for downloading. The selecting means may comprise a separate switch for each state or a switch actuable between each of the states. For example, in the case of a data display device for downloading a predetermined number of data items, such as, for example, eight data items, there may be a switch for each item or a switch actuable between any of the predetermined number of states or positions. Each switch or switch state may be indicated or coded using, for example, a corresponding colour or may have a respective icon, possibly downloaded to the data display device, or other indicia to allow the user to associate the states or positions and the data items. A switch or switches may be arranged, for example, such that a single actuation requests a single download, two actuations requests repetitive downloads and three actuations requests a download only if the data item changes.

In a preferred embodiment, the data display device is incorporated into a watch with a rotatable bezel around the rim of the watch serving as a selection means or selection mechanism, the bezel being rotatable to each of the predetermined number of positions or states. It will be appreciated that if the data display device is incorporated in other items, other existing elements or features of those items may be adapted to serve as selection means or mechanism or to present a number of positions or states. For instance, the actuation or clutch mechanism of a pen or pencil could serve as the selection means or mechanism.

The data capture means may comprise means responsive to requests for downloads from the data display device or to internally generated prompts to capture data.

The responsive means may capture data once or repeatedly. Captured data items may be evaluated so as to enable pre-selected actions, such as the updating of the data display device, to be performed. The data capture means may capture data items by extracting them from data sources. The data sources may be sites on the Internet or other data network, with the data items being pieces of information of a web page. The data capture means is further preferably adapted for access by the data specification means for specifying the data items.

The data capture means could be in the form of a computer server. The server may have an IP address so as to be accessible in the manner of a web site using a personal computer, laptop computer, a mobile telephone, WAP enabled device or any other Internet enabled device. The server may present web page type content for a user to specify the data items, which may be password or otherwise securely protected and may enable a user to modify the specification for data capture.

The data specification means may comprise any device capable of accessing the data capture means. For example, when the data capture means comprises a server computer, the data specification means may be a personal computer, laptop computer, a mobile telephone, WAP enabled devices or any other Internet enabled device. The data specification means may be provided with software to support access to the data capture means. The software may also facilitate configuration of the data display device. The data specification means and data capture means may communicate with one another as part of a configuration process for the device either directly or via a network.

A further aspect of embodiments of the present invention provide a computer program element comprising computer program code means to implement a system, device or personal article as described in this specification. Further embodiments provide a computer program product comprising computer readable storage or a computer readable storage medium having stored therein or thereon such a computer program element. The term computer program and computer program element refer to either a complete, that is, self-contained, program, or to part of a program, such as, for example, a library routine, a subroutine, a module or the like.

A still further aspect of embodiments of the present invention provides a data communication method comprising the steps of specifying a number of items of data using data specification means, capturing the specified items from data sources at the data capture means and downloading the items of data by wireless communication from the data capture means to a data display device, wherein the data display device is incorporated in a personal article, which article has an additional function.

Embodiments of the present invention further provide a data display device to download data items retrieved from a number of data sources without the use of browsing or equivalent-type software or function at the device, wherein the data display device is incorporated in an article personal to the user, which article has an additional function.

Preferably, embodiments provide a personal article comprising an input device, a display capable of displaying, in a first portion, data presenting an icon, the first portion being selectable using the input device, a transceiver comprising means, responsive to actuation of the input device to select the first portion, to request and receive data corresponding to the selected first portion and a display driver to display the received data in a second portion of display; the received data having been, prior to the request, previously selected, as being of interest, from at least one data source and, preferably, from a number of data sources.

The embodiments preferably comprise a personal article in which the input device comprises at least one of an actuable button or switch and a moveable member. In some embodiments, the moveable member might comprise a rotatable bezel for selecting at least the first portion of the display.

Embodiments of a personal article comprise a watch, key ring, pen, jewellery, or other adornment, a cutting implement or tool, a bag, a purse, a wallet, spectacles, a game or plaything, a camera or an item of clothing or footwear.

Preferred embodiments provide a watch comprising means to provide at least one chronographic function, an input device, a display, having a plurality of display regions and a data display portion, each region being capable of displaying a respective icon, a transceiver, responsive to actuation of the input device to select one of the plurality of display regions, to request and receive data corresponding to the selected region and a display driver to display the received data in the data display portion of the display.

Preferably, embodiments provide a watch in which the display regions form at least part of an annulus, the data display portion being is disposed within said at least partial annulus and in which the input device comprises a rotatable bezel disposed radially outward of said at least partial annulus; the bezel being rotatable to select one of the plurality of display regions. Embodiments are provided in which the bezel is rotatable to select the nearest region of the plurality of display regions.

The movement of the bezel may instantaneously cause a request for data to be sent as soon as the bezel assumes a predetermined position relative to a display region. However, this will increase the traffic and, hence, the power consumption requirements of the watch. Suitably, embodiments provide a watch comprising means to monitor the duration for which the bezel is adjacent to one of the plurality of display regions and in which the means to request and receive is arranged to request and receive the data according to the duration. Preferably, the duration should exceed a predetermined period of time.

Embodiments provide a watch further comprising a memory for storing at least one of icon data, representing an icon to be displayed in at least one of the plurality of display regions, and corresponding data to be displayed in the data display portion of the display. Preferably, embodiments provide a watch further comprising means to receive and store the icon data in the memory.

It is probable that the memory capacity of the watch is limited as compared with more sophisticated devices such as WAP phones. Therefore, the memory of the watch should preferably be managed prudently. Suitably, embodiments provide a watch further comprising means to receive metadata associated with the icon data and to reserve or configure a portion of the memory to store data according to the metadata. The metadata assists in the efficient utilisation of the memory of the watch.

A further aspect of embodiments of the present invention provides a data communication system comprising a selector to select data to be displayed on a display of a watch; the watch comprising: a memory, means to provide an indication of a current time, an input device, a display having a plurality of display sectors and a data display portion, each sector being capable of displaying a respective icon, a transceiver comprising means, responsive to actuation of the input device to select one of the plurality of sectors, to request and receive previously selected data corresponding to the selected sector and a display driver to display the received data in the data display portion of the display; the data communication system further comprising a configuration means to produce, responsive to the selected data, configuration data to configure the memory of the watch.

Advantageously, the configuration data supports the efficient use of the memory of the watch.

Preferably, the configuration data comprises at least one of icon data, representing an icon to be displayed in a sector of the plurality of display sectors, and metadata, associated with the previously selected data, to configure the memory to store the received data corresponding to the previously selected data.

The data may be selected from a single data source or from a number of data sources.

Once a user has selected or identified data of interest, a reference for that data should preferably be stored to allow it to be retrieved. Therefore, embodiments provide a data communication system in which the selector collates address data, corresponding the previously selected data, for processing by a data capture means; the data capture means being arranged to obtain a copy of the selected data using the address data. Advantageously, the collated data can be used by an application to retrieve copies of the selected or identified data.

It would be advantageous for a user to have some means of specifying the data to be retrieved. Suitably, embodiments provide a data communication system comprising a selector to identify data to be displayed on a display of a watch; the watch comprising: a memory, means to provide an indication of a current time, an input device, a display having a plurality of display regions and a data display portion, each region being capable of displaying a respective icon, a transceiver comprising means, responsive to actuation of the input device to select one of the plurality of display portions, to request and receive data corresponding to the selected region, said received data being associated with the identified data, and means to display the received data in the data display portion of the display; the selector collates address data corresponding to the identified data.

Embodiments provide a data communication system in which the collated address data is output for processing by a data capture means to obtain a copy of the identified data using the address data.

Embodiments provide a data communication system further comprising a configuration means, responsive to the identified data, to produce configuration data to configure the memory of the watch. Preferably, embodiments provide a data communication system in which the configuration data comprises at least one of icon data, representing an icon to be displayed in one of the display regions, and metadata, associated with the identified data, to configure the memory to store the received data associated with the identified data.

A further aspect of embodiments provides a data communication system comprising a personal article, a selector and a data capturer; the selector comprising means to select data to be displayed on a display of a personal article and to collate address data to locate the selected data; the data capturer being arranged, using the address data, to obtain a copy of the selected data; the personal article comprising: a memory, an input device, a display having a plurality of display regions and a data display portion, each display region being capable of displaying a respective icon, a transceiver comprising means, responsive to actuation of the input device to select one of the plurality of display regions, to request and receive a copy of previously selected data corresponding to the selected region and means to display the received data in the data display portion of the display.

The retrieval of the data of interest may be done in response to a request or at predetermined times or time intervals. Suitably, embodiments provide a data communication system in which the selector comprises means to specify data capture timing information to control the time at which the data capturer obtains the copy of the data. Preferably, the data capture means obtains the copy of the data in response to data capture timing information.

Preferred embodiments provide a data communication system in which the personal article is a watch.

Preferably, embodiments provide a data communication system in which the display regions are arranged in an annulus and the data display portion is disposed within the annulus and in which the input device comprises a bezel disposed radially outward of the annulus; the bezel being rotatable to select one of the plurality of display regions. Embodiments are provided in which the bezel is rotatable to select the nearest display region of the plurality of display regions.

Embodiments provide a data communication system further comprising means to monitor the duration for which the bezel is adjacent to one of the plurality of display regions and in which the transceiver is arranged to invoke the means to request and receive data according to that duration.

Preferably, embodiments of the data communication system further comprises a memory for storing at least one of icon data, representing an icon to be displayed in at least one of the plurality of display regions, and corresponding data to be displayed in the data display portion of the display. Preferably, embodiments provide means to receive and store the icon data in the memory. Still more preferably, embodiments provide a data communication system comprising means to receive the metadata associated with the icon data and to reserve or configure a portion of the memory according to the metadata.

A still further aspect of embodiments provides a data communication system comprising data specification means to allow specification of at least one data item, data capture means to capture the at least one data item from a data source and a device arranged to download the captured data item, by wireless communication, from the data capture means and to display the data item on a display of the device; wherein the device is a watch.

Alternatively, embodiments are provided in which the device is a key ring, a pen, jewellery or other adornment, a pen knife or tool, a bag, a purse or wallet, spectacles, a game or plaything, a camera, or an item of clothing or footwear rather than a watch.

A yet further aspect of embodiments of the present invention provides a computer program product comprising computer readable storage or a computer readable storage medium having stored therein or thereon computer program code means to implement a personal article comprising an input device, a display capable of displaying, in a first portion, data presenting an icon, the first portion being selectable using the input device, a transceiver comprising means, responsive to actuation of the input device to select the first portion, to request and receive data corresponding to the first portion and means to display the received data in a second portion of the display.

Another aspect of embodiments provides a computer program product comprising a computer readable storage medium or computer readable storage having stored thereon or therein computer program code means to implement a data communication system, personal article or watch, data specification means or selector, or a data capture means or data capturer as described in this specification.

A further aspect of embodiments of the present invention provides a data communication system comprising data specification means for a user to specify a number of items of data, data capture means for capturing the specified items of data from data sources and a data display device for downloading at least one of the captured items of data by wireless communication from the data capture means, wherein the data display device is incorporated in a watch.

Preferably, embodiments provide a data communication system in which the data display device in incorporated in a key ring, a pen, jewellery or other adornment, a pen knife or tool, a bag, a purse or wallet, spectacles, a game or plaything, a camera, or an item of clothing or footwear rather than a watch.

Yet a further aspect of the present invention provides a data communication method comprising specifying a number of items of data using data specification means, capturing the specified items from data sources at data capture means and downloading the items of data by wireless communication from the data capture means to a data display device, wherein the data display device is incorporated in a watch.

### BRIEF DESCRIPTION OF THE DRAWINGS

Embodiments of the present invention will now be described, by way of example, with reference to the following drawings, in which:

FIG. 1 is a schematic representation of a data communication system of an embodiment of the present invention;

FIG. 2 depicts a view of a data display device according to an embodiment of the present invention; and

FIG. 3 illustrates a number of flowcharts showing the processing undertaken by embodiments of the present invention.

### DETAILED DESCRIPTION OF PREFERRED EMBODIMENTS

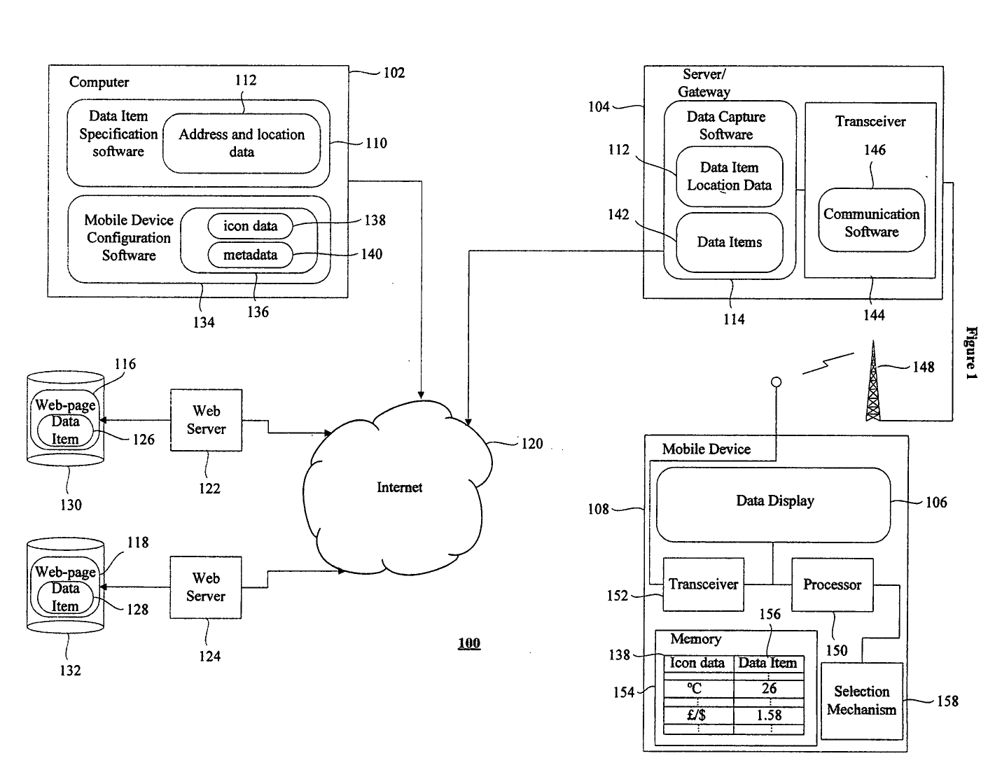

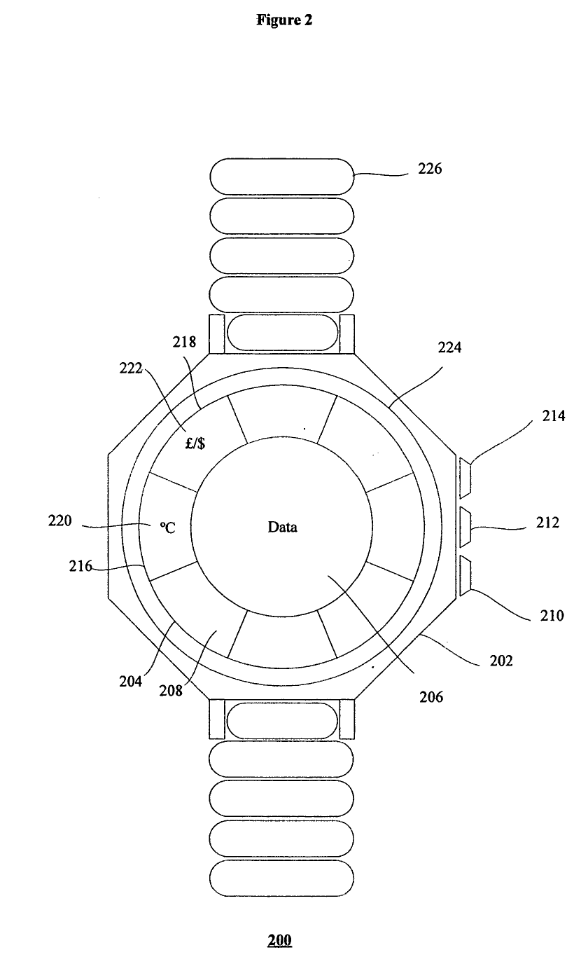

FIG. 1 is a schematic representation of an embodiment of a data communication system 100. The system 100 comprises a computer 102, a server 104 and a data display device 106 incorporated in a mobile device 108. In preferred embodiments the mobile device is a wristwatch, which is described later with reference to FIG. 2. The wristwatch may be a realisation of the mobile device or personal article.

The computer 102 comprises data item specification software 110 for browsing data sources to locate and specify data items of interest to the user. The computer 102, in conjunction with the software 110, represent a form of realisation of at least part of a data specification means or selector. The software 110 is used to compile address data 112 containing addresses of data items for transmission to, and use by, data capture software 114 executable at the server 104. The server 104 and the data capture software 114 represent a form of realisation of at least part of a data capture means or data capturer. In preferred embodiments, the address data 112 comprises URLs of web-pages, such as, for example web-pages 116 and 118, that are accessible by the Internet 120 and respective web-servers 122 and 124. For the purposes of illustration, the web-pages 116 and 118 are depicted as comprising respective data items 126 and 128 of interest to the user (not shown) stored on respective HDDs 130 and 132. The address data additionally comprises data identifying the specific location within the web-pages 116 and 118 of the data items 126 and 128 of interest.

In preferred embodiments, the data item specification software 110, in addition to collating address data 112 for data items of interest, also allows the time or frequency of retrieval of the data items to be specified, optionally, together with an indication of whether the data should be stored at the server in anticipation of receipt of a download request from the watch, forwarded to the wristwatch in anticipation of receipt of a request to display an item of data or forwarded to the wristwatch together with an indication that the user should be notified of the arrival of the data item or items.

The computer 102 also supports mobile device configuration software 134 that is used to configure the mobile device 108 to receive and display the data items 126 and 128 of interest. The configuration software 134 allows the user to select an icon to be associated with each data item 126 and 128. The icon will be displayed on the display of the mobile device to support selection of the data items for display. Preferably, the configuration software produces configuration data 136 comprising icon data 138, representing an icon or a number of icons, and metadata 140 that describes the data to be displayed or associated with the icon or icons.

The mobile device 108 may be configured using the configuration data 136 via any suitable form of communication channel. For example, the mobile device 108 may communicate with the computer 102 and receive the configuration data via a direct link. The direct link may be a direct physical link, such as, for example, USB or a radio link using, for example, Bluetooth, IEEE 802.11b or some other wireless protocol. Alternatively, the configuration data may be forwarded to the server 104 where the data capture software 114 can be arranged to forward the configuration data 136 to the mobile device using the existing radio communication infrastructure.

The server 104 comprises, as indicated above, data capture software 114 that retrieves, using the address data 112, and stores a copy 142 of a requested one of the data items 130 and 132. The request for one of the data items is received from the mobile device 108 via a radio transceiver 144 operating under the control of communication software 146. The transceiver 144 is arranged to exchange, via a suitable antenna 148, data with the mobile device 108 wirelessly.

The mobile device 108, as indicated above, comprises a display 106 for displaying, amongst other things, selected data items. The mobile device 108 comprises a processor 150, which in preferred embodiments, operates the device as a wristwatch and displays the time on the display 106. The processor 150 is also operable to support data exchanges, using a radio transceiver 152, with at least one of the server 104 and the mobile device configuration software 134. The mobile device 108 comprises a memory 154. The processor 150 is arranged to configure the memory 154 for storing the icon data 138 and, preferably or optionally, to configure the memory 154 in light of the metadata 140 to ensure that there is sufficient storage 156 available to store the selected data items associated with icon data 138, that is, the metadata is arranged to ensure that a sufficient number of words are available to store the selected data associated with the icon data. The memory 154 can store, in the described embodiment, up to eight icons and can be configured to store selected data items corresponding to the eight icons. The icons are displayed on the display 106 and can be selected using a corresponding selection mechanism or means 158. The selection mechanism or means 158 is used to select one of the displayed icons, which, in turn, causes a download request, corresponding to the selected icon, to be sent to the server 104 via the transceiver 152. The data capture software 114 returns the selected data item, extracted from the stored copies 142 of the data items, corresponding to the selected icon.

Referring to FIG. 2, there is shown a preferred embodiment of a mobile device 108 in the form a wristwatch 200. The wristwatch 200 comprises a body 202 bearing a liquid crystal display (LCD) 204. The LCD 204 comprises a central data display portion 206 and a number of peripheral display regions 208, which, together, perform the primary function of displaying the current time under the control of the processor 150. The time may be displayed in numerical form using appropriate digits or in an analogue-type form using simulated analogue hands. In preferred embodiments, the LCD comprises eight peripheral display regions. Preferably, the display regions form an annulus, with any given region being shaped as a truncated sector, or part annulus.

The regions 208 and data display portion 206 are used, as a secondary function, to display the icons and corresponding data items in response to user actuation of one of a number of control buttons 210 to 214. FIG. 2 shows two regions 216 and 218 as containing respective icons 220 and 222. In the illustrated example, the icons represent a current temperature, ° C., and a Sterling-Dollar exchange rate, £/$. A rotatable bezel 224 to select one of the display regions 208, that is, one of the regions containing an icon such as, for example, one of regions 216 and 218. A currently selected icon is, in a preferred embodiment, indicated by having an increased display intensity relative to the other icons. In a preferred embodiment, as the bezel is rotated, the display intensity of the currently selected icon is increased relative to the other icons, which all assume the same relatively lower intensity. Rotating the bezel 224 causes the change in intensity to step through the displayed icons, in effect, those regions that do not contain an icon are preferably not selectable. This facilitates speedier selection of a desired item of information. Selecting an icon using the bezel 224 automatically causes a download request, corresponding to the selected icon, to be transmitted to the server 104, which responds by forwarding the data item corresponding to the selected icon. The received data item is stored within one of the storage locations 156 corresponding to the selected icon and displayed on the central portion 206 of the LCD 204.

In preferred embodiments, the change in intensity is ephemeral, that is, it lasts for a predetermined period of time. This is done primarily to save power consumption.

The watch also comprises the customary bracelet, strap or other means 226 to allow it to be worn by the user.

It can be appreciated that the wristwatch, in addition to functioning as a watch, that is with time, date, chronograph, alarm etc. also has the additional function of being capable of displaying downloaded data.

The manner of use of the system is as follows: on purchasing a wristwatch 200, a user also receives the IP address of the server 104, an identification code, password and software corresponding to the data item specification software 110 and the mobile device configuration software 134. Using the software loaded on to the computer 102, the user gains access to a number of pages hosted by the server 104 that have the following objects: to enable up to eight Internet site web-pages to be identified, and then to further identify the location a specific data item embedded within the web-pages. The user may, for example, specify the address of a meteorological web page as one of the eight addresses, and within that page identify a temperature being reported, say, for a city. Another seven data items may be similarly identified. The user also specifies for each data item, the manner in which the data item should be captured. The capture might occur once in response to a request received from the wristwatch 200, repeatedly in response to a request received from the wristwatch 200 or repeatedly irrespective of a request having been received from the wristwatch 200. For example, a temperature reading for the city may be captured from the meteorological web page in response to a request or repeatedly following the request, or simply repeatedly in readiness for a request once specified. Having specified to the server 104 the data items to be retrieved together with the periodicity or frequency of retrieval, the server 104 can retrieve the specified data items at the appropriate time or times.

In preferred embodiments, on completion of a download, the wristwatch is arranged to produce an audible alert to indicate that the selected data item has been downloaded.

Having a continuing interest in the temperature, the user may execute a predetermined number, for example, two, of rapid movements of the bezel 224, to and from the “° C.” icon or region, consequently generating and communicating a request for repeated downloads to the server 104. In response, the server 104 monitors the data item, capturing it, for example, every hour and automatically downloads any change to the wristwatch 200. If the user no longer wishes to be updated regularly, the bezel 224 may be placed in a neutral position, consequently generating and communicating “stop monitoring message” that is sent to the server 104, which causes the data capture software to cease obtaining the data item. Alternatively, or additionally, the monitoring mode of the data capture software may be terminated, for a currently selected icon, using the buttons 210 to 214.

In an alternative embodiment the watch may be provided with icons pre-configured. This avoids the need for the user to go through the steps of selecting sites of interest, but obviously does not permit reselection of sites of interest. It is envisaged that, for example, in accordance with this embodiment, when purchasing the watch, the user will select a watch at least partly upon the basis of the sites with which it is configured. Alternatively configuration (and possibly reconfiguration) may take place at the retail outlet for example.

In a further modification the icons can be printed on a suitable substrate (re-writable if desired) at the time of configuration, thus obviating the need to provide a dedicated region of the watch's dynamic display for this purpose.

Other articles, such as key rings, pens or other writing instruments, jewellery or other adornments, pen knives or tools, bags, purses or wallets, spectacles, a game or plaything, or an item of clothing or footwear may not be normally provided with a display and, thus in order to adapt them for use as part of a data communication system, a display has to be provided in the case of a pen, for example, the display may be mounted of the body of the pen so as to be visible when held in normal writing manner. In the case of spectacles, by way of another example, the display could be a partially reflective surface to the lenses on to which information may be projected.

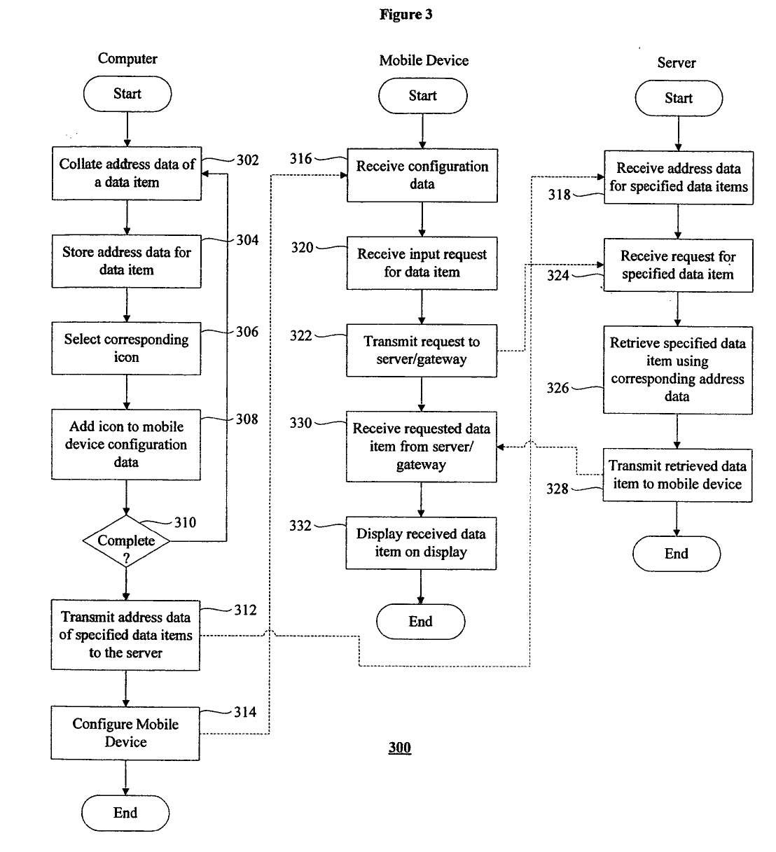

FIG. 3 shows a number of flowcharts 300 depicting the operation of an embodiment of the present invention. At step 302, the data item specification software collates address and location data for an item of interest. That address and location data is stored and added to an address data file 112 containing address and location data for previously selected data items, if any, at step 304. A corresponding icon to be display on the mobile device is selected at step 306. Data representing the icon at added, at step 308, to the mobile device configuration data 136 together with metadata describing the nature of the selected data item, such as, for example, the number of words required to store a selected data item. A determination is made, at step 310, as to whether or not the data item specification process has been completed. If the determination is that the data item specification process has not been completed, control is returned to step 302. If the determination is that the data item specification process has been completed, the file 112 containing the address and location data is transmitted to the server 104 for use by the data capture software 114 at step 312.

The mobile device is configured using the collated configuration data 136 at step 314. The configuration data 136 is received and acted upon by the mobile device at step 316. The configuration process involves storing the icon data in memory and ensuring that a sufficient number of words of the memory are associated with each icon data to allow the storage of data corresponding to any requested data.

The server 104, at step 318, receives the address data 112 for the specified data items and forwards that address data 112 to the data capture software 114.

The mobile device 108 detects an input representing a request for a data item from the user at step 320. A download request is generated and sent to the server 104 at step 322. The server 104 receives the download request at step 324. The data capture software 114, at step 326, retrieves, preferably, in real-time, the selected data item using the address and location data 112. At step 328, the retrieved data item is transmitted to the mobile device 108. The mobile device 108 receives the retrieved data item at step 330 and displays the received data item at step 332.

Although the above embodiments have been described with reference to the real-time download of data items from the web-pages 126 and 132 in response to download requests received from the wristwatch, embodiments are not limited to such an arrangement. For example, embodiments can be realised in which the data capture means retrieves the data items in advance and caches those items until requested by the user of the wristwatch. Alternatively, or additionally, the retrieved data items might be retrieved and forwarded to the memory of the wristwatch 200 in anticipation of user selection at some time in the future. Whether the data is downloaded in real-time or not will depend to a certain extent upon the time sensitivity or importance of the data.

Although the above embodiments have been described with reference to a download request being sent automatically to the server 104 upon selection of a region, embodiments are not limited to such an arrangement. Embodiments can be realised in which the automatic download request is not sent until one, or a combination, of the buttons 210 to 214 has been actuated. Alternatively, the download request may not be generated and sent until an icon or region has been selected for a predetermined period of time. In both embodiments, the amount of traffic generated by the selection process will be reduced as compared to embodiments in which the download requests are generated and sent automatically. This may have the additional advantage that the battery of the wristwatch may last longer since fewer transmissions are made as compared to the automatic generation and transmission of download requests.

The above embodiments have been described with reference to the intensity of the icons changing as the icons are selected using the bezel. However, embodiments of the present invention are not limited to such an arrangement. Embodiments can be realised in which the bezel comprises a marker that is used to indicate which icon is currently selected. The region or icon selected is that region or icon that is closest to the marker of the bezel 224. Furthermore, the embodiments of the present invention are not limited to using a bezel as the selection mechanism or means. Embodiments can be realised in which one, or a combination, of the buttons 210 to 214 can be used to select the icon of interest. For example, the first button 210, when depressed, in conjunction with the third button 214 may cause the currently selected icon to change intensity and each subsequent depression may select the next clockwise icon.

The above described data specification means is indicated as collating the address data of the selected data items. However, embodiments can be realised in which the data specification means, working with the data capture means, merely specifies the data items of interest and the data capture means collates the address data corresponding to those data items. Also, the data capture means can, in response to the user specifying the timing of the data capture, using the data specification means, be used to collate the timing information rather than that information being collated at the data specification means.

Furthermore, although the above embodiments have been described such that each display regions is operated to display icons, embodiments can be realised in which selected ones of the display regions are used to display icons, that is, in use, not all regions may be used to display icon data.

The above embodiments have been described with reference to the use of metadata to configure the memory of the mobile device. However, embodiments can be realised in which the memory of the device is pre-configured to receive data items have a particular size. Such embodiments would remove, or at least reduce, the need for metadata to be specified and transmitted to the mobile device. Furthermore, the collation of the metadata may be undertaken by the data capture means, which can then conveniently communicate that information to the mobile device using the transceiver 144 and communication software 146.

Advantageously, the embodiments of the present invention allow article, having a primary function, to assume also a secondary function, which is related to data display.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A personal article comprising an input device, a display capable of displaying, in a first portion, data presenting an icon, the first portion being selectable using the input device, a transceiver comprising means, responsive to actuation of the input device to select the first portion, to request and receive data corresponding to the selected first portion and a display driver to display the received data in a second portion of display; the received data having been, prior to the request, previously selected, as being of interest, from at least one data source, and, preferably, from a plurality of data sources.

2. A personal article as claimed in claim 1 in which the input device comprises at least one of an actuable button or switch and a moveable member.

3. A personal article as claimed in claim 2 in which the moveable member comprises a rotatable bezel for selecting at least the first portion of the display.

4. A personal article as claimed claim 1 in which the article is one of a watch, key ring, pen, jewellery, or other adornment, a cutting implement or tool, a bag, a purse, a wallet, spectacles, a game or plaything, a camera or an item of clothing or footwear.

5. A watch comprising means to provide at least one chronographic function, an input device, a display, having a plurality of display regions and a data display portion, each region being capable of displaying a respective icon, a transceiver, responsive to actuation of the input device to select one of the plurality of display regions, to request and receive data corresponding to the selected region and a display driver to display the received data in the data display portion of the display.

6. A watch as claimed in claim 5 in which the display regions form at least part of an annulus, the data display portion being is disposed within said at least partial annulus and in which the input device comprises a rotatable bezel disposed radially outward of said at least partial annulus; the bezel being rotatable to select one of the plurality of display regions.

7. A watch as claimed in claim 6 in which the bezel is rotatable to select the nearest region of the plurality of display regions.

8. A watch as claimed in claim 6 further comprising means to monitor the duration for which the bezel is adjacent to one of the plurality of display regions and in which the means to request and receive is arranged to request and receive the data according to the duration.

9. A watch as claimed in claim 8 in which the duration exceeds a predetermined period of time.

10. A watch as claimed in claim 5 further comprising a memory for storing at least one of icon data, representing an icon to be displayed in at least one of the plurality of display regions, and corresponding data to be displayed in the data display portion of the display.

11. A watch as claimed in claim 10 further comprising means to receive and store the icon data in the memory.

12. A watch as claimed in claim 10 further comprising means to receive metadata associated with the icon data and to reserve or configure a portion of the memory to store data according to the metadata.

13. A data communication system comprising a selector to select data to be displayed on a display of a watch; the watch comprising a memory, means to provide an indication of a current time, an input device, a display having a plurality of display sectors and a data display portion, each sector being capable of displaying a respective icon; a transceiver comprising means, responsive to actuation of the input device to select one of the plurality of sectors, to request and receive previously selected data corresponding to the selected sector and a display driver to display the received data in the data display portion of the display; the data communication system further comprising a configuration means to produce, responsive to the selected data, configuration data to configure the memory of the watch.

14. A data communication system as claimed in claim 13 in which the configuration data comprises at least one of icon data, representing an icon to be displayed in a sector of the plurality of display sectors, and metadata, associated with the previously selected data, to configure the memory to store the received data corresponding to the previously selected data.

15. A data communication system as claimed in claim 13 in which the selector collates address data, corresponding the previously selected data, for processing by a data capture means; the data capture means being arranged to obtain a copy of the selected data using the address data.

16. A data communication system comprising a selector to identify data to be displayed on a display of a watch; the watch comprising a memory, means to provide an indication of a current time, an input device, a display having a plurality of display regions and a data display portion, each region being capable of displaying a respective icon, a transceiver comprising means, responsive to actuation of the input device to select one of the plurality of display portions, to request and receive data corresponding to the selected region, said received data being associated with the identified data, and means to display the received data in the data display portion of the display; the selector collates address data corresponding to the identified data.

17. A data communication system as claimed in claim 16 in which the collated address data is output for processing by a data capture means to obtain a copy of the identified data using the address data.

18. A data communication system as claimed in claim 16 further comprising a configuration means, responsive to the identified data, to produce configuration data to configure the memory of the watch.

19. A data communication system as claimed in claim 18 in which the configuration data comprises at least one of icon data, representing an icon to be displayed in one of the display regions of the plurality of display regions, and metadata, associated with the identified data, to configure the memory to store the received data associated with the identified data.

20. A data communication system comprising a personal article, a selector and a data capturer; the selector comprising means to select data to be displayed on a display of the personal article and to collate address data to locate selected data; the data capturer being arranged, using the address data, to obtain a copy of the selected data; the personal article comprising: a memory, an input device, the aforesaid display, having a plurality of display regions and a data display portion, each display region being capable of displaying a respective icon, a transceiver comprising means, responsive to actuation of the input device to select one of the plurality of display regions, to request and receive previously selected data corresponding to the selected region and means to display the received data in the data display portion of the display.

21. A data communication system as claimed in claim 20 in which the selector comprises means to specify data capture timing information to control the time at which the data capturer obtains the copy of the data.

22. A data communication system as claimed in claim 21 in which the data capturer obtains the copy of the data in response to data capture timing information.

23. A data communication system as claimed in claim 20 in which the personal article is a watch.

24. A data communication system as claimed in claim 23 in which the display region are arranged in an annulus and the data display portion is disposed within the annulus, and in which the input device comprises a bezel disposed radially outward of the annulus; the bezel being rotatable to select one of the plurality of display regions.

25. A data communication system as claimed in claim 24 in which the bezel is rotatable to select the nearest display segment of the plurality of display regions.

26. A data communication system as claim 25 further comprising means to monitor the duration for which the bezel is adjacent to one of the plurality of display regions and in which the transceiver is arranged to invoke the means to request and receive data according to that duration.

27. A data communication system as claimed in claim 20 further comprising a memory for storing at least one of icon data, representing an icon to be display in at least one of the plurality of display regions, and corresponding data to be displayed on the data display portion of the display.

28. A data communication system as claimed in claim 27 further comprising means to receive and store the icon data in the memory.

29. A data communication system as claimed in claim 28 comprising means to the receive metadata associated with the icon data and to reserve or configure a portion of the memory according to the metadata.

30. A data communication system comprising data specification means to allow specification of at least one data item, data capture means to capture the at least one data item from a data source and a device arranged to download the captured data item, by wireless communication, from the data capture means and to display the data item on a display of the device; wherein the device is a watch.

31. A data communication system as claimed in claim 30 in which the device is a key ring, a pen, jewellery or other adornment, a pen knife or tool, a bag, a purse or wallet, spectacles, a game or plaything, a camera, or an item of clothing or footwear rather than a watch.

32. A computer program product comprising computer readable storage or a computer readable storage medium having stored therein or thereon computer program code means to implement a personal article comprising an input device, a display capable of displaying, in a first portion, data presenting an icon, the first portion being selectable using the input device, a transceiver comprising means, responsive to actuation of the input device to select the first portion, to request and receive data corresponding to the first portion and means to display the received data in a second portion of the display.

33. A computer program product comprising a computer readable storage medium or computer readable storage having stored thereon or therein computer program code means to implement a data communication system, personal article or watch as in claim 1.

34. A watch having:
a visual monitor upon which the time is displayable;
a selection device that provides a visual indication of a plurality of data sources, and that is operable by a user to select one of the data sources;
a transceiver connected to the selection device that is operable to request and receive data from a selected data source; and
a display driver adapted to display data received from a selected source on the monitor.

35. A watch according to claim 34 wherein the selection device includes a display upon which icons representing the data sources are displayed.

36. A watch according to claim 35 wherein the display of the selection device is a region of the visual monitor.

37. A watch according to claim 35 wherein the selection device includes an actuator operable manually to select an icon.

38. A watch according to claim 35 wherein the icons are receivable via a data input port.

39. A watch according to claim 38 wherein the data input port includes the transceiver.

40. A watch according to claim 35 wherein the icons are permanently configured in the watch.
